(19) United States
(12) Patent Application Publication
(10) Pub. No.: US 2015/0228464 A1
(43) Pub. Date: Aug. 13, 2015

(54) Systems and Methods for Utilizing Accurate Mass Information for Elemental Composition Determination

(71) Applicant: DH TECHNOLOGIES DEVELOPMENT PTE. LTD., Singapore (SG)

(72) Inventors: Eva Duchoslav, Toronto (CA); Ronald F. Bonner, Richmond Hill (CA); Lyle Burton, Woodbridge (CA)

(21) Appl. No.: 14/617,805

(22) Filed: Feb. 9, 2015

Related U.S. Application Data
(60) Provisional application No. 61/938,324, filed on Feb. 11, 2014.

(51) Int. Cl. H01J 49/00

(52) U.S. Cl. CPC H01J 49/004; H01J 49/0036

(57) ABSTRACT

A precursor ion spectrum and one or more product ion spectra are received from a tandem mass spectrometer that analyzes a compound. For a selected precursor ion peak in the precursor ion spectrum, mass differences are calculated between other peaks and one or more limitations on the number of elements in the selected precursor ion are generated. For a precursor ion peak, a product ion spectrum is located from the one or more product ion spectra. For a selected product ion peak in the product ion spectrum, mass differences between other peaks are calculated and one or more limitations on the number of elements in the selected product ion are generated. Limitations on the number of elements from the precursor ion and the product ions are combined. One or more elemental compositions are generated from a mass of the selected precursor ion peak and the combined limitations.

### CROSS REFERENCE TO RELATED APPLICATION

This application claims the benefit of U.S. Provisional Patent Application Ser. No. 61/938,324, filed Apr. 11, 2014, the content of which is incorporated by reference herein in its entirety.

### INTRODUCTION

Compound identification is a significant bottleneck in qualitative mass spectrometry workflows, particularly for unknown compounds that are not present in spectral libraries. Current approaches are generally mass spectrometry (MS) or nuclear magnetic resonance (NMR) driven and assign elemental compositions based on an accurate mass and isotope pattern for a single isotope cluster in the mass spectrum. The quality of the result depends on several factors including: the actual mass accuracy (calibration and instrument dependent), the mass of the ions (heavier ions have more compositions within a given error), and the number of different elements considered in the calculation. To identify true unknowns, the number of elements allowed should be large, potentially including less common species, but this increases the number of matching compositions for a given mass tolerance.

For example, for a mass, X, measured by a mass spectrometer, it is possible to generate a list of every possible chemical formula that has a mass X within a mass measurement error of the mass spectrometer. Although finite, such a list can grow large with increasing mass. In addition, the size of the list is dependent on the mass measurement error of the mass spectrometer. The greater the measurement error, the larger the list of possible chemical formulae.

Mass spectrometry/mass spectrometry (MS/MS) information has also been used to reduce the list of possible chemical formulae for a compound. In a typical conventional system, MS data is used to predict a list of possible chemical formulae. A chemical formula from the list is then selected manually. If MS/MS data is available, product ion data from the MS/MS is scored based on the selected chemical formula. MS/MS data is, therefore, used to verify the selected chemical formula.

### SUMMARY

A system is disclosed for generating one or more elemental compositions for a precursor ion using tandem mass spectrometry precursor ion and product ion mass or mass to charge ratio (m/z) difference measurements. The system includes a tandem mass spectrometer and a processor.

The tandem mass spectrometer analyzes a compound, producing a precursor ion spectrum and one or more product ion spectra for one or more precursor ions in the precursor ion spectrum.

The processor receives the precursor ion spectrum and the one or more product ion spectra from the tandem mass spectrometer. For a selected precursor ion peak in the precursor ion spectrum, the processor calculates mass differences, m/z differences, or neutral losses between other peaks in the precursor ion spectrum, producing a plurality of precursor ion peak mass differences, m/z differences or neutral losses.

The processor further generates one or more limitations on the number of elements in the selected precursor ion from the plurality of precursor ion peak mass differences, m/z differences, or neutral losses. The processor further locates a product ion spectrum. For a selected product ion peak in the product ion spectrum, the processor calculates mass differences, m/z differences, or neutral losses between other peaks in the product ion spectrum, producing a plurality of product ion peak mass differences, m/z differences, or neutral losses.

The processor further generates one or more limitations on the number of elements in the selected product ion from the plurality of product ion peak mass differences, m/z differences, or neutral losses, producing a plurality of limitations on the number of elements in the selected product ion.

The processor further combines the plurality of limitations on the number of elements in the selected product ion with one or more limitations on the number of elements in the selected precursor ion peak, producing a combined list of elemental limitations for the selected precursor ion peak.

The processor further generates one or more elemental compositions for the selected precursor ion peak from a mass or m/z of the selected precursor ion peak and the list of elemental limitations for the selected precursor ion peak

A method is disclosed for generating one or more elemental compositions for a precursor ion using tandem mass spectrometry precursor ion and product ion mass or m/z difference measurements.

A precursor ion spectrum and one or more product ion spectra are received from a tandem mass spectrometer that analyzes a compound using a processor.

For a selected precursor ion peak in the precursor ion spectrum, mass differences, m/z differences, or neutral losses between other peaks in the precursor ion spectrum differences are calculated using the processor. A plurality of precursor ion peak mass differences, m/z differences, or neutral losses are produced.

One or more limitations on the number of elements in the selected precursor ion are generated from the plurality of precursor ion peak mass differences, m/z differences, or neutral losses using the processor.

A product ion spectrum is generated using the processor.

For a selected product ion peak in the product ion spectrum, mass differences, m/z differences, or neutral losses between other peaks in the product ion spectrum are calculated using the processor. A plurality of product ion peak mass differences, m/z differences, or neutral losses are produced.

One or more limitations on the number of elements in the selected product ion are generated from the plurality of product ion peak mass differences, m/z differences, or neutral losses using the processor. A plurality of limitations on the number of elements in the selected product ion are produced.

The plurality of limitations on the number of elements in the selected product ion are combined with one or more limitations on the number of elements in the selected precursor ion peak using the processor. A combined list of elemental limitations for the selected precursor ion peak is produced.

One or more elemental compositions for the selected precursor ion peak are generated from a mass or m/z of the selected precursor ion peak and the list of elemental limitations for the selected precursor ion peak using the processor.

A computer program product is disclosed that includes a non-transitory and tangible computer-readable storage medium whose contents include a program with instructions being executed on a processor so as to perform a method for generating one or more elemental compositions for a precursor ion using tandem mass spectrometry precursor ion and product ion mass or m/z difference measurements. In various embodiments, the method includes providing a system, wherein the system comprises one or more distinct software modules, and wherein the distinct software modules comprise a measurement module and a composition module.

The measurement module receives a precursor ion spectrum and one or more product ion spectra from a tandem mass spectrometer that analyzes a compound. For s selected precursor ion peak in the precursor ion spectrum, the composition module calculates mass differences, m/z differences, or neutral losses between other peaks in the precursor ion spectrum. A plurality of precursor ion peak mass differences, m/z differences, or neutral losses are produced.

The composition module generates one or more limitations on the number of elements in the selected precursor ion from the plurality of precursor ion peak mass differences, m/z differences, or neutral losses.

The composition module locates a product ion spectrum.

For a selected product ion peak in the product ion spectrum, the composition module calculates mass or neutral losses between other peaks in the product ion spectrum. A plurality of product ion peak mass differences, m/z differences, or neutral losses are produced.

The composition module generates one or more limitations on the number of elements in the selected product ion from the plurality of product ion peak mass differences, m/z differences, or neutral losses. A plurality of limitations on the number of elements in the selected product ion are produced.

The composition module combines the plurality of limitations on the number of elements in the selected product ion with one or more limitations on the number of elements in the selected precursor ion peak. A combined list of elemental limitations for the selected precursor ion peak is produced.

The composition module generates one or more elemental compositions for the selected precursor ion peak from a mass or m/z of the selected precursor ion peak and the list of elemental limitations for the selected precursor ion peak.

These and other features of the applicant's teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is a schematic diagram showing a system for generating one or more elemental compositions for a precursor ion using tandem mass spectrometry precursor ion and product ion mass difference measurements, in accordance with various embodiments.

FIG. 3 is an exemplary flowchart showing a method for generating one or more elemental compositions for a precursor ion using tandem mass spectrometry precursor ion and product ion mass difference measurements, in accordance with various embodiments.

FIG. 4 is a schematic diagram of a system that includes one or more distinct software modules that performs a method for generating one or more elemental compositions for a precursor ion using tandem mass spectrometry precursor ion and product ion mass difference measurements, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

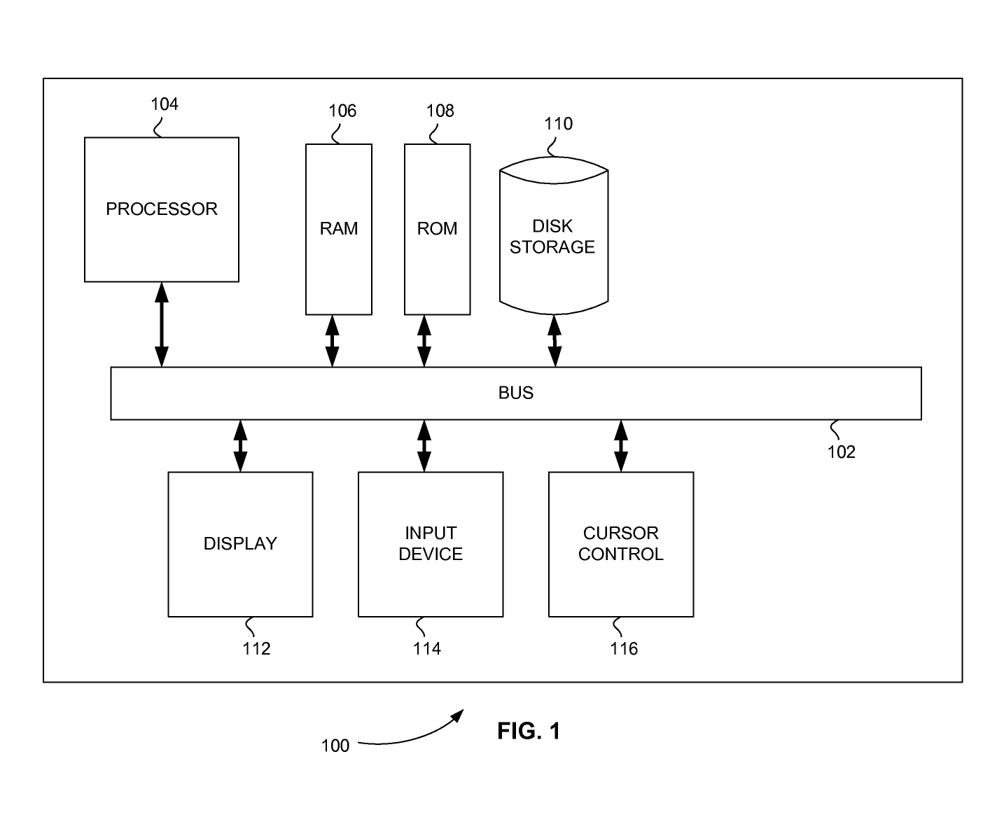

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively hard-wired circuitry may be used in place of or in combination with software instructions to implement the present teachings. Thus implementations of the present teachings are not limited to any specific combination of hardware circuitry and software.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Systems and Methods for Identifying Compounds

As described above, compound identification is a significant bottleneck in qualitative mass spectrometry workflows, particularly for unknown compounds that are not present in spectral libraries. Current approaches are generally mass spectrometry (MS) or nuclear magnetic resonance (NMR) driven and assign elemental compositions based on an accurate mass and isotope pattern for a single isotope cluster in the MS mass spectrum.

For example, for a mass, X, measured by a mass spectrometer, it is possible to generate a list of every possible chemical formula that has a mass X within a mass measurement error of the mass spectrometer. Although finite, such a list can grow large with increasing mass and decreasing mass accuracy.

In addition, mass spectrometry/mass spectrometry (MS/MS) information has also been used to reduce the list of possible chemical formulae for a compound. In a typical conventional system, MS data is used to predict a list of possible chemical formulae. A chemical formula from the list is selected manually. MS/MS data is, then, used to verify the selected chemical formula.

In various embodiments, the improved mass accuracy of modem mass spectrometry instruments across a mass range allows complementary measurements in both MS and MS/MS to be used to determine partial elemental compositions of an unknown compound. Complementary measurements include, for example, mass differences, mass to charge ratio (m/z) differences, or neutral losses. Such complementary measurements are much less likely to be affected by bias in mass calibration than the m/z itself.

In various embodiments, the chemical space is adjusted based on accurate mass measurements, rather than finding the best elemental composition within a given chemical space. A given chemical space is conventionally defined by, for example, element ranges, number of double bond equivalents (DBEs), etc. The chemical space is adjusted using both MS and MS/MS information. By taking advantage of information from complementary MS and MS/MS measurements and assuming that the instrument performance, namely mass assignment reproducibility is within its established specification, the allowed element ranges for the elemental composition assignment are efficiently restricted, leading to a smaller set of more relevant results.

Information from complementary MS and MS/MS measurements can include, but is not limited to, ion type information, dimer or other adduct information, internal fragment information, neutral losses, charge states, isotope ratios, DBE information, and information obtained from positive and negative ion experiments. Ion type information includes, for example, relationships that identify potential molecular ions. Internal fragment information includes, for example, ions corresponding to neutral losses from likely molecular ions such as H₂O, CO₂, etc. Neutral losses, for example, are losses or differences with respect to an intact ion. Information obtained from positive and negative ion experiments includes, for example, measurements made from both positive and negative polarities of a mass spectrometer. Some mass spectrometers allow polarity switching in a timely fashion from positive to negative mode or negative to positive mode.

In various embodiments, adjustments to the chemical space are made automatically from the MS and MS/MS measurements. As described above, conventionally MS/MS data has been used to verify elemental compositions that are selected manually from lists of elemental compositions generated from MS data. In contrast, various embodiments automatically determine limitations on elemental compositions from the MS and MS/MS data independently. A union of the limitations from the MS and MS/MS data is then used to generate a list of one or more elemental compositions for the molecular ion.

In various embodiments, differences in mass or m/z in MS and MS/MS data are used to determine one or more elemental compositions for the molecular ion. Differences in mass or m/z are used, because differences most often have a higher mass accuracy than absolute values. For example, if all the masses of a spectrum are substantially affected in the same way (shift to higher or lower mass) by the measurement error of the mass spectrometer, then all masses have substantially the same absolute error. If all of the masses have substantially the same absolute error, then the differences between any two of them are going to be more accurate than any absolute values. Once an elemental composition of a molecular ion is found, the elemental composition of the neutral molecule can be found based upon ion type, for example.

### System for Identifying Elemental Compositions for a Precursor Ion

A system for identifying one or more elemental compositions of an unknown molecular ion includes a tandem mass spectrometer. The tandem mass spectrometer produces MS and MS/MS data. The MS data is, for example, a precursor ion spectrum. The MS/MS data is, for example, one or more product ion spectra. The unknown molecular ion is represented by a precursor ion peak in the precursor ion spectrum. The one or more elemental compositions of the unknown molecular ion are found from mass differences, m/z differences, or neutral losses in the precursor ion spectrum and the one or more product ion spectra.

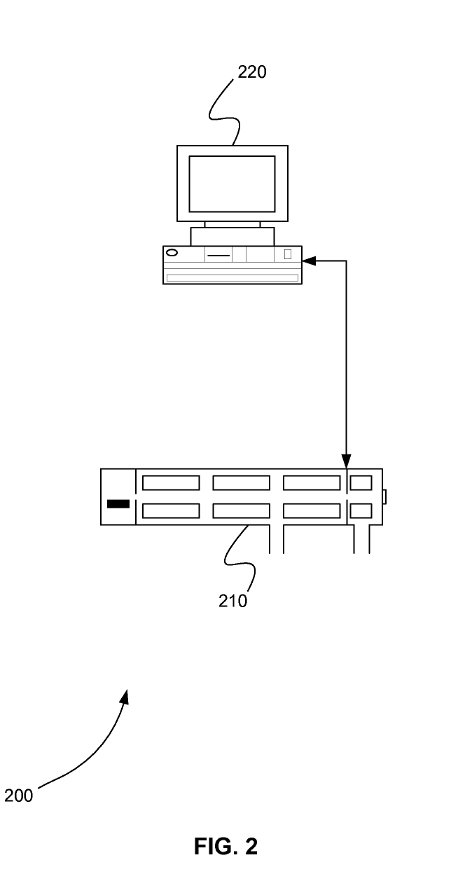

FIG. 2 is a schematic diagram showing a system 200 for generating one or more elemental compositions for a precursor ion using tandem mass spectrometry precursor ion and product ion mass difference measurements, in accordance with various embodiments. System 200 includes tandem mass spectrometer 210 and processor 220.

Tandem mass spectrometer 210 can include one or more physical mass analyzers that perform two or more mass analyses. A mass analyzer of a tandem mass spectrometer can include, but is not limited to, a time-of-flight (TOF), quadrupole, an ion trap, a linear ion trap, an orbitrap, or a Fourier transform mass analyzer. Tandem mass spectrometer 210 can also include a separation device (not shown). The separation device can perform a separation technique that includes, but is not limited to, liquid chromatography, gas chromatography, capillary electrophoresis, or ion mobility. Tandem mass spectrometer 210 can include separating mass spectrometry stages or steps in space or time, respectively. Tandem mass spectrometer 210 can, for example, provide high mass accuracy across a mass range.

Processor 220 can be, but is not limited to, a computer, microprocessor, or any device capable of sending and receiving control signals and data from tandem mass spectrometer 210 and processing data. Processor 220 is in communication with tandem mass spectrometer 210.

Tandem mass spectrometer 210 analyzes a compound. Tandem mass spectrometer 210 produces a precursor ion spectrum and one or more product ion spectra for one or more precursor ions in the precursor ion spectrum from the analysis.

Processor 220 receives the precursor ion spectrum and the one or more product ion spectra from the tandem mass spectrometer. In one embodiment, processor 220 receives the precursor ion spectrum and the one or more product ion spectra from the tandem mass spectrometer as part of a post acquisition analysis step.

In an alternative embodiment, processor 220 receives the precursor ion spectrum and the one or more product ion spectra from the tandem mass spectrometer during data acquisition. For example, processor 220 receives the precursor ion spectrum, analyzes the precursor ion spectrum, and then instructs tandem mass spectrometer 210 to produce each of the one or more product ion spectra based on the analysis of the precursor ion spectrum.

Processor 220 first determines one or more limitations on the number of elements for a peak from mass differences, m/z differences, or neutral losses found in MS data. For a selected precursor ion peak in the precursor ion spectrum, processor 220 calculates mass differences, m/z differences, or neutral losses between other peaks in the precursor ion spectrum, producing a plurality of precursor ion peak mass differences. For the selected precursor ion peak in the precursor ion spectrum, processor 220 generates one or more limitations on the number of elements in the precursor ion from the plurality of precursor ion peak mass differences, m/z differences, or neutral losses.

In various embodiments, before selecting the selected precursor ion peak or before determining the one or more limitations on the number of elements for the selected precursor ion peak, processor 220 orders the selected precursor ion peaks from most intense to least intense. Processor 220 starts analyzing the most intense precursor ion peaks first.

Next, processor 220 locates MS/MS data for the selected precursor ion in the MS data and determines additional limitations on the number of elements for the precursor ion from mass differences, m/z differences, or neutral losses in the MS/MS data. Processor 220 locates a product ion spectrum. For a selected product ion peak in the product ion spectrum, processor 220 calculates mass differences between other peaks in the product ion spectrum, producing a plurality of product ion peak mass differences, m/z differences, or neutral losses. For the selected product ion peak in the product ion spectrum, processor 220 generates one or more limitations on the number of elements in the product ion from the plurality of product ion peak mass differences, m/z differences, or neutral losses, producing a plurality of limitations on the number of elements in the selected product ion.

Processor 220 combines the plurality of limitations on the number of elements in the selected product ion with the one or more limitations on the number of elements in the selected precursor ion peak, producing a list of elemental limitations for the selected precursor ion peak. Processor 220 generates one or more elemental compositions for the selected precursor ion peak from the mass of the selected precursor ion peak and the list of elemental limitations for the selected precursor ion peak.

In various embodiments, processor 220 analyzes the selected product ion in the product ion spectrum producing a plurality of limitations on the number of elements for the selected product ion in the product ion spectrum. The plurality of limitations on the number of elements in the selected product ion are then combined with the one or more limitations on the number of elements in the selected precursor ion peak, producing a list of elemental limitations for the selected precursor ion peak.

In various embodiments, processor 220 can also analyze the selected precursor ion in the precursor ion spectrum.

In various embodiments, ion types are used to generate one or more limitations on the number of elements in a precursor ion. Processor 220 generates one or more limitations on the number of elements in a precursor ion from the plurality of precursor ion peak mass differences, m/z differences, or neutral losses by comparing each mass difference, m/z difference, or neutral loss of the plurality of precursor ion peak mass differences, m/z differences, or neutral losses to masses of known ion types. Processor 220 combines limitations on the number of elements of matching neutral losses with the one or more limitations on the number of elements in the selected precursor ion.

For example, if processor 220 calculates a mass difference of 21.982 Da between two ion peaks, a comparison with known ion types suggests that the lower ion peak is of the form M+H⁻ and the higher ion peak is of the form M+Na⁺. Therefore, from the comparison processor 220 determines a limitation on both the lower ion peak and the higher ion peak. The lower ion peak must contain at least one hydrogen atom. The higher peak must contain at least one sodium atom.

In various embodiments, ion types are also used to generate one or more limitations on the number of elements in the selected product ion. Processor 220 generates one or more limitations on the number of elements in the selected product ion from the plurality of product ion peak mass difference, m/z difference, or neutral by comparing each mass difference, m/z difference, or neutral loss of the plurality of product ion peak mass differences, m/z differences, or neutral losses to masses of known ion types. Processor 220 combines limitations on the number of elements of matching ion types with the one or more limitations on the number of elements in the selected product ion.

In various embodiments, dimers or adducts are used to generate one or more limitations on the number of elements in the selected precursor ion. Processor 220 generates one or more limitations on the number of elements in the selected precursor ion from the plurality of precursor ion peak mass differences, m/z differences, or neutral losses by comparing each mass difference, m/z difference, or neutral loss of the plurality of precursor ion peak mass differences, m/z differences, or neutral losses to masses of known adducts or dimers. Processor 220 combines limitations on the number of elements of matching adducts or dimers with the one or more limitations on the number of elements in the selected precursor ion.

In various embodiments, neutral losses are used to generate one or more limitations on the number of elements in the selected precursor ion. Processor 220 generates one or more limitations on the number of elements in the selected precursor ion from the plurality of precursor ion peak mass differences, m/z differences, or neutral losses by comparing each mass difference, m/z difference, or neutral loss e of the plurality of precursor ion peak mass differences, m/z differences, or neutral losses to masses of known neutral losses. Processor 220 adds limitations on the number of elements of matching neutral losses to the one or more limitations on the number of elements in the selected precursor ion.

For example, processor 220 can align a precursor ion spectrum and a product ion spectrum and determine that a peak common to both spectra is an internal fragment. An internal fragment is, for example, an ion fragmented by the ion source of the tandem mass spectrometer. From this information, processor 220 can analyze the precursor spectrum for neutral losses from molecules such as H₂O and CO₂, for example.

In various embodiments, tandem mass spectrometer 210 further analyzes the compound in positive and negative mode to generate one or more limitations on the number of elements in the selected precursor ion. Processor 220 further generates one or more limitations on the number of elements in the selected precursor ion by comparing a mass difference, m/z difference, or neutral loss between the selected precursor ion with positive polarity and the selected precursor ion with negative polarity and adding a limitation on the number of elements based on the mass difference found.

For example, if a precursor ion peak has a mass of 101 Da in positive and a mass of 99 Da in negative mode, this is strong evidence that the neutral molecule is charged with hydrogen rather than sodium or potassium, for example. In other words, this is strong evidence that the adduct is not sodium, potassium, or any other adduct with a mass greater than 1 Da. It is also evidence that the adduct may be one hydrogen atom.

In various embodiments, one or more limitations on the number of elements in the selected product ion are also found by using tandem mass spectrometer 210 to analyze the compound in positive and negative mode. Processor 220 further generates one or more limitations on the number of elements in the selected product ion by comparing a mass difference, m/z difference, or neutral between the selected product ion with positive polarity and the selected product ion with negative polarity and adding a limitation on the number of elements based on the mass difference, m/z difference, or neutral found.

In various embodiments, processor 220 generates elemental compositions for the selected product ion and adds them to the list of elemental limitations. Processor 220 further generates one or more elemental compositions for the selected product ion, producing a plurality of product ion elemental compositions. Processor 220 adds the plurality of product ion elemental compositions to the list of elemental limitations for the selected precursor ion peak.

If a product ion corresponds to the loss of a neutral from the precursor ion, then this information can be used as a limitation on the precursor ion's composition. For example, if a product ion is formed by a loss of CO from the precursor ion, then a limitation on the number of elements in the precursor ion is at least one carbon atom and at least one oxygen atom. Likewise, this information provides a limitation on the composition of the product ion. The product ion has one less carbon atom and one less oxygen atom than the precursor ion. In various embodiments, processor 220 further examines the product ion spectra for accurate mass differences that cannot be explained by the list of elemental limitations. Processor 220 compares the plurality of product ion peak mass differences to the list of elemental limitations for the selected precursor ion peak. Processor 220 determines non-matching mass differences that do not correspond to any elemental limitations on the list of elemental limitations for the selected precursor ion peak. Processor 220 combines other elements that correspond to the non-matching mass differences with the list of elemental limitations for the selected precursor ion peak.

In various embodiments, processor 220 determines the most likely composition for the molecular ion of the compound. Processor 220 further selects one elemental composition from the one or more elemental compositions for the selected precursor ion peak as the molecular ion of the compound.

### Method for Identifying Elemental Compositions for a Precursor Ion

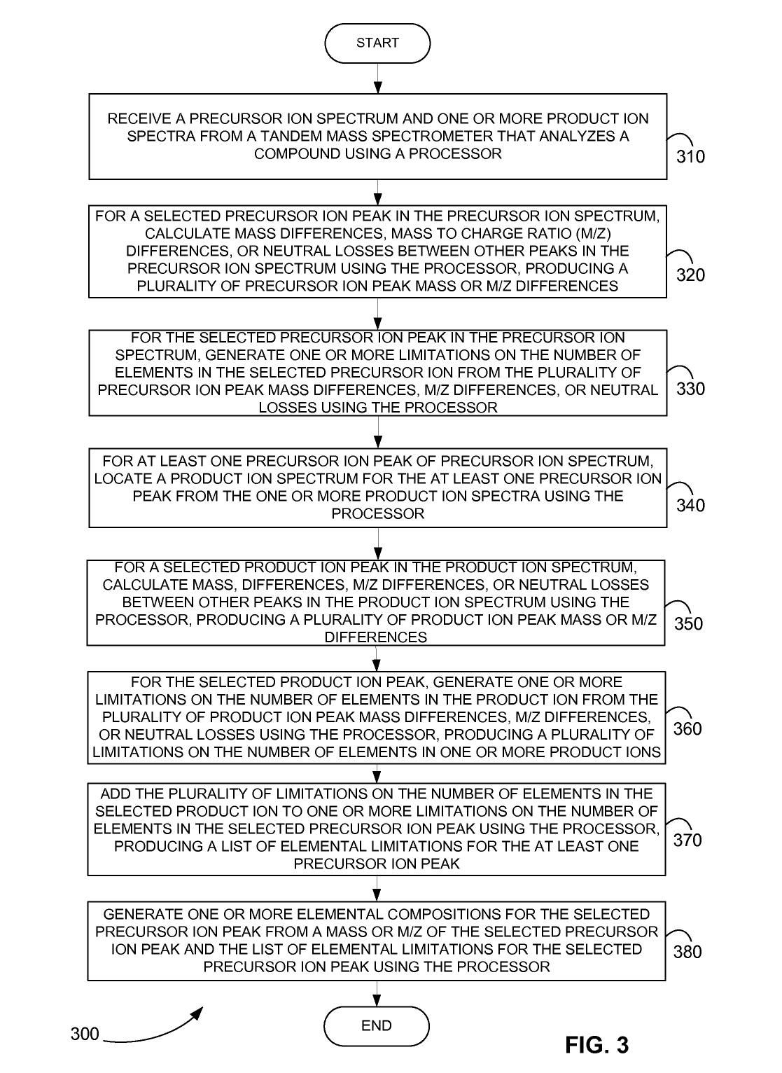

FIG. 3 is an exemplary flowchart showing a method 300 for generating one or more elemental compositions for a precursor ion using tandem mass spectrometry precursor ion and product ion mass difference measurements, in accordance with various embodiments.

In step 310 of method 300, a precursor ion spectrum and one or more product ion spectra are received from a tandem mass spectrometer that analyzes a compound using a processor.

In step 320, for a selected precursor ion peak in the precursor ion spectrum, mass differences, mass to charge ratio (m/z) differences, or neutral losses are calculated between other peaks in the precursor ion spectrum using the processor. A plurality of precursor ion peak mass or m/z differences are produced.

In step 330, for the selected precursor ion peak in the precursor ion spectrum, one or more limitations on the number of elements in the selected precursor ion are generated from the plurality of precursor ion peak mass differences, m/z differences, or neutral losses using the processor.

In step 340, a product ion spectrum is located using the processor.

In step 350, mass differences, m/z differences, or neutral losses between a selected product ion peak and other peaks in the product ion spectrum are calculated using the processor. A plurality of product ion peak mass differences, m/z differences, or neutral losses are produced.

In step 360, one or more limitations on the number of elements in the selected product ion are generated from the plurality of product ion peak mass differences, m/z differences, or neutral losses using the processor. A plurality of limitations on the number of elements in the selected product ion are produced.

In step 370, the plurality of limitations on the number of elements in the selected product ion are combined with one or more limitations on the number of elements in the selected precursor ion peak using the processor. A list of elemental limitations for the selected precursor ion peak is produced.

In step 380, one or more elemental compositions for the selected precursor ion peak are generated from a mass or m/z of the selected precursor ion peak and the list of elemental limitations for the selected precursor ion peak using the processor.

### Computer Program Product for Identifying Elemental Compositions for a Precursor Ion

In various embodiments, a computer program product includes a tangible computer-readable storage medium whose contents include a program with instructions being executed on a processor so as to perform a method for generating one or more elemental compositions for a precursor ion using tandem mass spectrometry precursor ion and product ion mass difference measurements. This method is performed by a system that includes one or more distinct software modules.

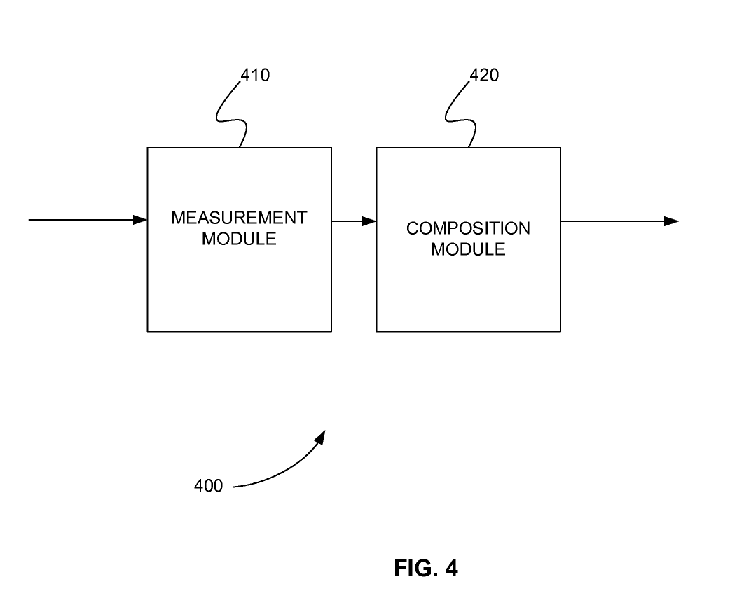

FIG. 4 is a schematic diagram of a system 400 that includes one or more distinct software modules that performs a method for generating one or more elemental compositions for a precursor ion using tandem mass spectrometry precursor ion and product ion mass difference measurements, in accordance with various embodiments. System 400 includes measurement module 410 and composition module 420.

Measurement module 410 receives one or more product ion spectra from a tandem mass spectrometer that analyzes a compound. For s selected precursor ion peak in the precursor ion spectrum, composition module 420 calculates mass differences, mass to charge ratio (m/z) differences, or neutral losses between other peaks in the precursor ion spectrum. A plurality of precursor ion peak mass differences, m/z differences, or neutral losses are produced. For a precursor ion peak in the precursor ion spectrum, composition module 420 generates one or more limitations on the number of elements in the selected precursor ion from the plurality of precursor ion peak mass differences, m/z differences, or neutral losses.

For the selected precursor ion peak of precursor ion spectrum, composition module 420 locates a product ion spectrum. For a product ion peak in the product ion spectrum, composition module 420 calculates mass differences, m/z differences, or neutral losses between other peaks in the product ion spectrum. A plurality of product ion peak mass differences, m/z differences, or neutral losses are produced. For the selected product ion peak in the product ion spectrum, composition module 420 generates one or more limitations on the number of elements in the selected product ion from the plurality of product ion peak mass differences, m/z differences, or neutral losses. A plurality of limitations on the number of elements in the selected product ion are produced.

Composition module 420 combines the plurality of limitations on the number of elements in the selected product ion with one or more limitations on the number of elements in the selected precursor ion peak. A list of elemental limitations for the selected precursor ion peak is produced. Composition module 420 generates one or more elemental compositions for the selected precursor ion peak from a mass or m/z of the selected precursor ion peak and the list of elemental limitations for the selected precursor ion peak.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for generating one or more elemental compositions for a precursor ion using tandem mass spectrometry precursor ion and product ion mass or m/z difference measurements, comprising:
a tandem mass spectrometer that analyzes a compound, producing a precursor ion spectrum and one or more product ion spectra for one or more precursor ions in the precursor ion spectrum; and
a processor in communication with the tandem mass spectrometer that
receives the precursor ion spectrum and the one or more product ion spectra from the tandem mass spectrometer,
for a selected precursor ion peak in the precursor ion spectrum, calculates mass differences, mass to charge ratio (m/z) differences, or neutral losses between other peaks in the precursor ion spectrum, producing a plurality of precursor ion peak mass differences, m/z differences or neutral losses,
generates one or more limitations on the number of elements in the selected precursor ion from the plurality of precursor ion peak mass differences, m/z differences, or neutral losses,
locates a product ion spectrum,
for a selected product ion peak in the product ion spectrum, calculates mass differences, m/z differences, or neutral losses between other peaks in the product ion spectrum, producing a plurality of product ion peak mass differences, m/z differences, or neutral losses,
generates one or more limitations on the number of elements in the selected product ion from the plurality of product ion peak mass differences, m/z differences, or neutral losses, producing a plurality of limitations on the number of elements in the selected product ion,
combines the plurality of limitations on the number of elements in the selected product ion with one or more limitations on the number of elements in the selected precursor ion peak, producing a combined list of elemental limitations for the selected precursor ion peak, and
generates one or more elemental compositions for the selected precursor ion peak from a mass or m/z of the selected precursor ion peak and the list of elemental limitations for the selected precursor ion peak.

2. The system of claim 1, wherein the processor calculates mass differences, m/z differences, or neutral losses between other peaks in the product ion spectrum for two or more product ion peaks in the product ion spectrum.

3. The system of claim 1, wherein before determining the one or more limitations on the number of elements for the selected precursor ion peak, the processor orders precursor ion peaks from most intense to least intense and starts analyzing the most intense precursor ion peaks first.

4. The system of claim 1, wherein the processor generates one or more limitations on the number of elements in the selected precursor ion from the plurality of precursor ion peak mass differences, m/z differences, or neutral losses by
comparing each mass difference, m/z difference, or neutral loss of the plurality of precursor ion peak mass differences, m/z differences, or neutral losses to masses or mass to charge ratios of known ion types and combining limitations on the number of elements of matching ion types with the one or more limitations on the number of elements in the selected precursor ion.

5. The system of claim 1, wherein the processor generates one or more limitations on the number of elements in the selected product ion from the plurality of product ion peak mass differences, m/z differences, or neutral losses by
comparing each mass difference, m/z difference, or neutral loss of the plurality of product ion peak mass differences, m/z differences, or neutral losses to masses or mass to charge ratios of known neutral losses and combining limitations on the number of elements of matching neutral losses with the one or more limitations on the number of elements in the selected product ion.

6. The system of claim 1, wherein the processor generates one or more limitations on the number of elements in the selected precursor ion from the plurality of precursor ion peak mass differences, m/z differences, or neutral losses by
comparing each mass difference, m/z difference, or neutral loss of the plurality of precursor ion peak mass differences, m/z differences, or neutral losses to masses or mass to charge ratios of known dimers or adducts and combining limitations on the number of elements of matching dimers or adducts to the one or more limitations on the number of elements in the selected precursor ion.

7. The system of claim 1, wherein the tandem mass spectrometer further analyzes the compound in positive and negative mode and the processor further generates one or more limitations on the number of elements in the selected precursor ion by
comparing a mass difference, m/z difference, or neutral loss between the selected precursor ion with positive polarity and the selected precursor ion with negative polarity and combining a limitation on the number of elements based on the mass difference, m/z difference, or neutral loss found.

8. The system of claim 1, wherein the tandem mass spectrometer further analyzes the compound in positive and negative modes and the processor further generates one or more limitations on the number of elements in the selected product ion by
comparing a mass difference, m/z difference, or neutral loss between the selected product ion with positive polarity and the selected product ion with negative polarity and combining a limitation on the number of elements based on the mass difference, m/z difference, or neutral loss found.

9. The system of claim 1, wherein the processor further generates one or more elemental compositions for the selected product ion, producing a plurality of product ion elemental compositions, and adds the plurality of product ion elemental compositions to the list of elemental limitations for the selected precursor ion peak.

10. The system of claim 1, wherein the processor further compares the plurality of product ion peak mass differences, m/z differences, or neutral losses to the list of elemental limitations for the selected precursor ion peak, determines non-matching mass differences, m/z differences, or neutral losses that do not correspond to any elemental limitations on the list of elemental limitations for the selected precursor ion peak, and adds other elements that correspond to the non-matching mass differences, m/z differences, or neutral losses to the list of elemental limitations for the selected precursor ion peak.

11. A method for generating one or more elemental compositions for a precursor ion using tandem mass spectrometry precursor ion and product ion mass or m/z difference measurements, comprising:
receiving a precursor ion spectrum and one or more product ion spectra from a tandem mass spectrometer that analyzes a compound using a processor;
for a selected precursor ion peak in the precursor ion spectrum, calculating mass differences, mass to charge ratio (m/z) differences, or neutral losses between other peaks in the precursor ion spectrum differences using the processor, producing a plurality of precursor ion peak mass differences, m/z differences, or neutral losses;
generating one or more limitations on the number of elements in the selected precursor ion from the plurality of precursor ion peak mass differences, m/z differences, or neutral losses using the processor;
locating a product ion spectrum using the processor;
for a selected product ion peak in the product ion spectrum, calculating mass differences, m/z differences, or neutral losses between other peaks in the product ion spectrum using the processor, producing a plurality of product ion peak mass differences, m/z differences, or neutral losses;
generating one or more limitations on the number of elements in the selected product ion from the plurality of product ion peak mass differences, m/z differences, or neutral losses using the processor, producing a plurality of limitations on the number of elements in the selected product ion;
combining the plurality of limitations on the number of elements in the selected product ion with one or more limitations on the number of elements in the selected precursor ion peak using the processor, producing a combined list of elemental limitations for the selected precursor ion peak, and
generating one or more elemental compositions for the selected precursor ion peak from a mass or m/z of the selected precursor ion peak and the list of elemental limitations for the selected precursor ion peak using the processor.

12. The method of claim 11, further comprising calculating mass differences, m/z differences, or neutral losses between other peaks in the product ion spectrum for two or more product ion peaks in the product ion spectrum using the processor.

13. The method of claim 11, further comprising generating one or more elemental compositions for the selected product ion using the processor, producing a plurality of product ion elemental compositions, and combining the plurality of product ion elemental compositions with the list of elemental limitations for the selected precursor ion peak.

14. The method of claim 11, wherein the generating the one or more limitations steps includes comparing each mass difference, m/z difference, or neutral loss of the plurality of precursor ion peak mass differences, m/z differences, or neutral losses to masses or mass to charge ratios of known ion types and combining limitations on the number of elements of matching ion types with the one or more limitations on the number of elements in the selected precursor ion using the processor.

15. The method of claim 11, wherein the generating the one or more limitations steps includes comparing each mass difference, m/z difference, or neutral loss of the plurality of precursor ion peak mass differences, m/z differences, or neutral losses to masses or mass to charge ratios of known dimers or adducts and combining limitations on the number of elements of matching dimers or adducts to the one or more limitations on the number of elements in the selected precursor ion.

16. The method of claim 11, further comprising generating one or more elemental compositions for the selected product ion, producing a plurality of product ion elemental compositions, and adding the plurality of product ion elemental compositions to the list of elemental limitations for the selected precursor ion peak using the processor.

17. The method of claim 11, further comprising comparing the plurality of product ion peak mass differences, m/z differences, or neutral losses to the list of elemental limitations for the selected precursor ion peak, determining non-matching mass differences, m/z differences, or neutral losses that do not correspond to any elemental limitations on the list of elemental limitations for the selected precursor ion peak, and adding other elements that correspond to the non-matching mass differences, m/z differences, or neutral losses to the list of elemental limitations for the selected precursor ion peak using the processor.

18. A computer program product, comprising a non-transitory and tangible computer-readable storage medium whose contents include a program with instructions being executed on a processor so as to perform a method for generating one or more elemental compositions for a precursor ion using tandem mass spectrometry precursor ion and product ion mass or m/z difference measurements, the method comprising:
providing a system, wherein the system comprises one or more distinct software modules,
and wherein the distinct software modules comprise a measurement module and a composition module;
receiving a precursor ion spectrum and one or more product ion spectra from a tandem mass spectrometer that analyzes a compound using the measurement module;
for a selected precursor ion peak in the precursor ion spectrum, calculating mass differences, mass to charge ratio (m/z) differences, or neutral losses between other peaks in the precursor ion spectrum differences using the composition module, producing a plurality of precursor ion peak mass differences, m/z differences, or neutral losses,
generating one or more limitations on the number of elements in the selected precursor ion from the plurality of precursor ion peak mass differences, m/z differences, or neutral losses using the composition module;
locating a product ion spectrum using the composition module;
for a selected product ion peak in the product ion spectrum, calculating mass or neutral losses between other peaks in the product ion spectrum using the composition module, producing a plurality of product ion peak mass differences, m/z differences, or neutral losses;
generating one or more limitations on the number of elements in the selected product ion from the plurality of product ion peak mass differences, m/z differences, or neutral losses using the composition module, producing a plurality of limitations on the number of elements in the selected product ion;
combining the plurality of limitations on the number of elements in the selected product ion with one or more limitations on the number of elements in the selected precursor ion peak using the composition module, producing a combined list of elemental limitations for the selected precursor ion peak, and
generating one or more elemental compositions for the selected precursor ion peak from a mass or m/z of the selected precursor ion peak and the list of elemental limitations for the selected precursor ion peak using the composition module.

19. The computer program product of claim 18, wherein the method further comprises calculating mass differences, m/z differences, or neutral losses between other peaks in the product ion spectrum for two or more product ion peaks in the product ion spectrum using the composition module.

20. The computer program product of claim 18, wherein the method further comprises generating one or more elemental compositions for the selected product ion, producing a plurality of product ion elemental compositions, and combining the plurality of product ion elemental compositions with the list of elemental limitations for the selected precursor ion peak using the composition module.
